(19) United States
(12) Patent Application Publication
(10) Pub. No.: US 2007/0177119 A1
(43) Pub. Date: Aug. 2, 2007

(54) EXPOSURE APPARATUS AND DEVICE MANUFACTURING METHOD

(76) Inventor: Keiko Chiba, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/670,279

(22) Filed: Feb. 1, 2007

(30) Foreign Application Priority Data
Feb. 2, 2006 (FR) 2006-026213
Jan. 29, 2007 (JP) 2007-017281

(51) Int. Cl. G03B 27/42

(52) U.S. Cl. 355/53; 355/30

(57) ABSTRACT

An exposure apparatus exposes a substrate via liquid, and includes a liquid holding plate configured to hold the liquid, and arranged around the substrate, and a chuck configured to hold the substrate, at least one of at least part of a surface of the liquid holding plate and at least part of a surface of the chuck being made of polyparaxylene resin or including a modified layer of polyparaxylene resin.

### BACKGROUND OF THE INVENTION

The present invention relates to an immersion exposure apparatus and a device manufacturing method.

A reduction projection exposure apparatus has been conventionally used to manufacture fine devices, such as a semiconductor memory and a logic circuit, using the photolithography technology. The reduction projection exposure apparatus projects a circuit pattern of a reticle (mask) onto a substrate, such as a wafer, via a projection optical system.

The minimum critical dimension (or resolution) transferable by the reduction projection exposure apparatus is proportionate to a wavelength of the light used for exposure, and inversely proportionate to the numerical aperture (“NA”) of the projection optical system. The shorter the wavelength is and the higher the NA is, the smaller the resolution is. Along with the recent demand for the fine processing to a semiconductor device, use of a shorter wavelength of the exposure light is promoted. For example, use of the ultraviolet (“UV”) light having a shorter wavelength is promoted from a KrF excimer laser (with a wavelength of approximately 248 nm) to an ArF excimer laser (with a wavelength of approximately 193 nm).

With this background, the immersion exposure is one attractive resolution improving technology that uses a light source, such as the ArF excimer laser. The immersion exposure increases an apparent NA of the projection optical system and improves the resolution by filling the liquid in a space between the final lens of the projection optical system and the wafer (or by replacing the medium at the wafer side of the projection optical system with the liquid) and by shortening the effective wavelength of the exposure light. The NA of the projection optical system is defined as NA=n×sin θ, where n is a refractive index of the medium. The NA increases up to n when the medium has a refractive index higher than the air's refractive index, i.e., n>1.

A local fill method is proposed for the immersion exposure, which locally fills the liquid in a space between the final lens of the projection optical system and the wafer. The local fill method locally circulates the liquid through the space between the final lens of the projection optical system and the wafer, maintains constant the optical characteristic, the thermal characteristic, etc., and supplies the liquid free from impurities. When the supplied liquid is not sufficiently recovered, the liquid residue sprays in the exposure apparatus or forms a water mark. In addition, the residual liquid evaporates, and negatively affects part and the environmental temperature and humidity in the exposure apparatus. In particular, any liquid residue on a liquid holding plate (or liquid holder) that holds the liquid in exposing edge areas of the wafer varies the temperature of the liquid holding plate due to the heat of evaporation, consequently deforming the wafer. In addition, the liquid enters the space between the wafer edge and the liquid holding plate, and the wafer moves with the liquid on its rear surface in the exposure apparatus, dispersing the liquid in the exposure apparatus.

When a contact angle to the liquid on the top surface of the liquid holding plate is greater than a contact angle of the top surface of the wafer (i.e., the contact angle of wafer's top surface<the contact angle of liquid holding plate's top surface), the liquid can be recovered sufficiently and the liquid residue on the top surface of the liquid holding plate can be prevented. Accordingly, one proposed exposure apparatus uses poly tetra fluoro ethylene resin as a material having good hydrophobic property of the liquid holding plate's top surface that contacts the liquid. See Japanese Patent Application, Publication No. 2005-302880. Moreover, it is known to use Parylene as an elastic seal to prevent the reticle's distortion and vacuum leakage in supporting the reticle and the wafer. See Japanese Patent Application, Publication No. 2005-228978.

The immersion exposure provides the liquid and (exposure) light between the projection optical system and the wafer. When the light or its scattered light is irradiated onto the projection optical system and a component around the wafer under the presence of the liquid, the light damages these elements more significantly than that in a conventional exposure apparatus that has only the light between the projection optical system and the wafer. This is more conspicuous as a wavelength of the exposure light becomes shorter.

When the light is irradiated onto the component, the light cuts a bond of the component and forms a dangling bond, which can be bonded with the liquid or a material included in the liquid, denaturing the component. In addition, the component chemically reacts with the liquid and may denature. The denatured component would consequently deteriorate its performance or can become a particle source. Even when contact angles of the liquid holding plate and wafer chuck's side surface are maintained high in manufacturing the immersion exposure apparatus, irradiations of the exposure light and its scattered light via the liquid would denature the liquid holding plate and wafer chuck's side surface, reducing their contact angles. In other words, continual exposures reduce the contact angles of the liquid holding plate and the wafer chuck's side surface, causing the liquid to be left on the liquid holding plate and wafer's rear surface, to spray in the exposure apparatus, or to generate particles from the liquid holding plate.

In particular, a fluorine material is likely to deteriorate due to the exposure light irradiations, and can maintain its initial high contact angle only for a limited period. Since the liquid holding plate made of the fluorine material lowers the low hydrophobic property or generates particles, the liquid holding plate needs to be replaced for every several weeks, lowering the productivity or throughput of the exposure apparatus.

### SUMMARY OF THE INVENTION

The present invention is directed to an exposure apparatus that can restrain a deterioration of its component that receives the exposure light, and maintain a good optical characteristic and productivity.

An exposure apparatus according to one aspect of the present invention exposes a substrate via liquid, and includes a liquid holding plate configured to hold the liquid, and arranged around the substrate, and a chuck configured to hold the substrate, at least one of at least part of a surface of the liquid holding plate and at least part of a surface of the chuck being made of polyparaxylene resin or including a modified layer of polyparaxylene resin.

A further object and other characteristics of the present invention will be made clear by the preferred embodiments described below referring to accompanying drawings.

### BRIEF DESCRIPTION OF THE DRAWINGS

FIG. 1 is a schematic sectional view showing a structure of an exposure apparatus according to one aspect of the present invention.

FIG. 2 is a graph showing a contact angle variation of polyparaxylylene resin to the UV dose.

FIGS. 3A and 3B are plane and sectional views of illustrative structures of a liquid holding plate and a wafer chuck in the exposure apparatus shown in FIG. 1.

FIGS. 4A and 4B are plane and sectional views of other illustrative structures of the liquid holding plate and wafer chuck in the exposure apparatus shown in FIG. 1.

FIG. 5 is a flowchart for explaining a manufacture of a device.

FIG. 6 is a flowchart for a wafer process of step 4 shown in FIG. 5.

### DESCRIPTION OF THE EMBODIMENTS

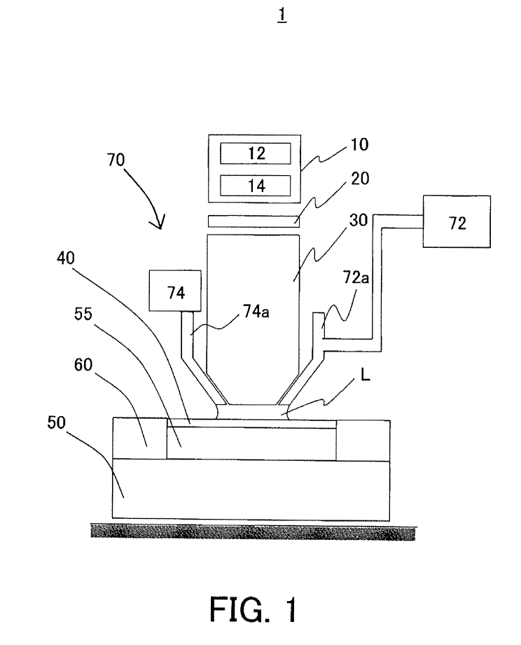

Referring now to the accompanying drawings, a description will be given of an exposure apparatus according to one embodiment of the present invention. In each figure, the same reference numeral designates the same element, and a duplicate description thereof will be omitted. Here, FIG. 1 is a schematic sectional view showing a structure of the exposure apparatus 1 of this embodiment.

The exposure apparatus 1 is an immersion exposure apparatus that exposes a pattern of a reticle 20 onto a wafer 40 via liquid L that is supplied in a space between the wafer 40 and a final lens of a projection optical system 30, which final lens is closest to the wafer 40 among the optical elements in the projection optical system 30.

The exposure apparatus 1 uses a step-and-scan exposure manner to expose the wafer 40. However, the exposure apparatus 1 can use a step-and-repeat manner.

The exposure apparatus 1 includes an illumination apparatus 10, a projection optical system 30, a wafer chuck 55 that sucks and holds a wafer 40, a liquid holding plate 60, and a liquid supply/recovery mechanism 70. The wafer chuck 55 and the liquid holding plate 60 are provided on the wafer stage 50.

The illumination optical system 10 illuminates the reticle 20, and includes a light source 12 and an illumination optical system 14.

The light source 12 uses the ArF excimer laser with the wavelength of approximately 193 nm, but can use an F₂ laser with a wavelength of approximately 157 nm.

The illumination optical system 14 illuminates the reticle 20 using the light from the light source 12.

The reticle 20 has a circuit pattern to be exposed onto the wafer 40, and is supported and driven by the reticle stage (not shown).

The projection optical system 30 projects the pattern of the reticle 20 onto the wafer 40. The projection optical system 30 can use a dioptric, catadioptric, or catoptric optical system.

The projection optical system 30 has a final lens closest to the wafer 40. A glass material for the final lens of the projection optical system 30 uses quartz.

A photoresist is applied to the top surface of the wafer 40. While this embodiment uses the wafer 40 for the substrate, the substrate may be a glass plate and another substrate.

The wafer stage 50 supports the wafer 40 via the wafer chuck 55, and drives the wafer 40.

The wafer stage 50 is provided with a liquid holder or liquid holding plate 60 around the wafer 40. The liquid holding plate 60 has a surface level with the surface of the wafer 40, and holds the liquid L, as shown in FIG. 1.

The liquid supply/recovery mechanism 70 supplies the liquid L to the space between the projection optical system 30 and the wafer 40, and collects the supplied liquid L from the space. The liquid supply/recovery mechanism 70 has a liquid supply unit 72 and a liquid recovery unit 74, and locally fills the liquid in the space between the projection optical system 30 and the wafer 40.

The liquid L is pure water, but may use functional water, fluoride liquid, and hydrocarbon liquid.

The liquid supply unit 72 has a supply nozzle 72a. The liquid supply unit 72 supplies the liquid L to the space between the projection optical system 30 and the wafer 40 via the supply nozzle 72a.

The liquid recovery unit 74 has a recovery nozzle 74a. The liquid recovery unit 74 collects the liquid L from the space between the projection optical system 30 and the wafer 40 via the recovery nozzle 74a.

The supply nozzle 72a and the recovery nozzle 74a enclose the outer circumference of the final lens of the projection optical system, and hold the liquid L between the projection optical system 30 and the wafer 40. The supply nozzle 72a and the recovery nozzle 74a can use plural nozzles, a movable nozzle or a ring nozzle, but this embodiment uses plural nozzles.

The supply nozzle 72a and the recovery nozzle 74a are made of a Si porous body that contains Si but may use another ceramic material, such as AlO and SiN, a quartz glass material, and metal, such as electropolished stainless steel.

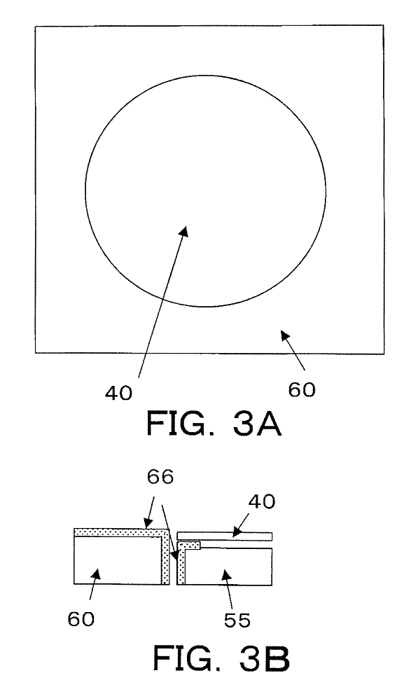

FIGS. 3A and 3B are schematic plane and sectional views showing structures of the liquid holding plate and the wafer chuck. The liquid holding plate 60 may use a ceramic material, such as SiC, AlO, and SiN, and metal, such as aluminum and stainless steel, but this embodiment can use SiC. Since SiC has a contact angle of about 50° to water, polyparaxylylene resin 66 is coated on it. Polyparaxylylene resin is generally referred to as Parylene, and is polymer (resin) with polyparaxylylene as a basic structure. Polymonochloroparaxylylene and polydichloroparaxylylene which replace hydrogen in an aromatic ring with chlorine are frequently used for polyparaxylylene resin. This embodiment coats the Polymonochloroparaxylylene on SiC through vapor deposition so that the top surface (liquid contacting surface) that holds the liquid L and the side surface of the liquid holding plate 60 can be made of Parylene. Parts of the side and top surfaces of the wafer chuck 55 are also made of polyparaxylylene resin 66. While this embodiment coats polyparaxylylene resin 66 on both the liquid holding plate 60 and the wafer chuck 55, coating of only one of them is effective in preventing an adhesion of liquid to the wafer's rear surface.

Parylene has a contact angle between 85° and 90° to water, and the contact angle increases up to 100° or greater with UV irradiations. In other words, a modified layer of Palylene has a higher contact angle to water than Palylene. Therefore, in order to improve the throughput by moving the wafer 40 quickly for a long distance, it is effective to coat the modified layer of UV irradiated Parelyne on the surfaces, such as a top surface and a side surface, of the liquid holding plate 60 and the wafer chuck. The UV irradiations onto the liquid holding plate 60 or the wafer chuck 55 may be made through a unit different from the exposure apparatus 1 or the illumination apparatus 10 in the exposure apparatus 1. In addition, the UV light may be irradiated in the liquid (water) L. Any types of modifications of Parylene, such as a modification through plasma processing, may be applied as long as the modified layer has a higher contact angle.

More specifically, the Parylene coated liquid holding plate 60 is arranged in a vacuum unit to flow the reactive gas for plasma processing, and to form a modified layer of Parylene. Similar to UV irradiated Parylene, plasma processed Parylene provides a higher contact angle.

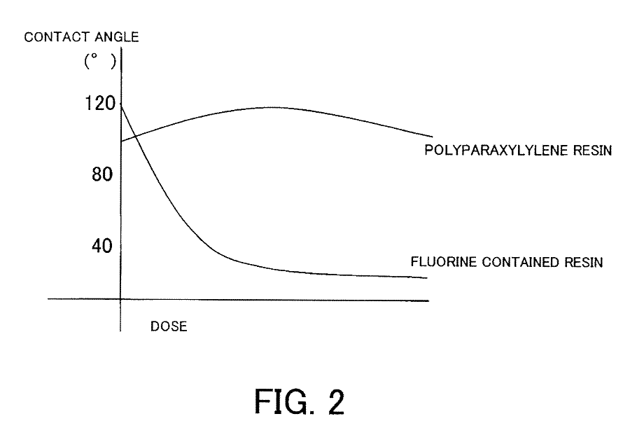

FIG. 2 shows a contact angle variation when the exposure light (which is the UV light having a wavelength of 193 nm in this embodiment) is irradiated onto Parylene in water, where an ordinate axis denotes a contact angle, and an abscissa angle denotes an exposure light dose. FIG. 2 also shows, as a comparative example, a contact angle variation of fluorine contained resin when the exposure light is irradiated under the same condition. Referring to FIG. 2, Referring to FIG. 2, the contact angle before the UV light is irradiated, fluorine contained resin, such as PTFE and PFA, has a higher contact angle, but once the UV light as the exposure light is irradiated, Parylene has and can maintain a higher contact angle for a long time.

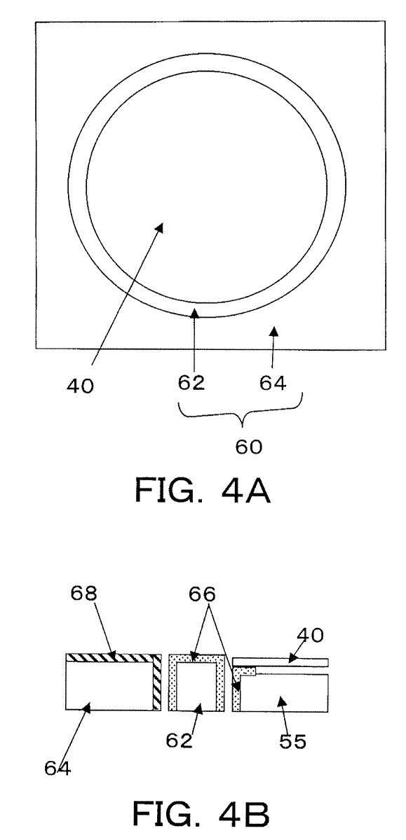

In the liquid holding plate 60, Parylene or a modified layer of Parylene may be coated only on an area (first liquid holding plate) 62, to which the exposure light or scattered light of the exposure light is irradiated. The area 62 is separate from an area (second liquid holding plate) 64 in the liquid holding plate 60, to which the exposure light or scattered light of the exposure light is not irradiated. Here, FIG. 4A is a schematic plane view showing another illustrative structure of the liquid holding plate 60, and FIG. 4B is a schematic sectional view showing another illustrative structure of the liquid holding plate 60. The area 62 is preferably made replaceable. Since a contact angle is maintained, irrespective of the UV irradiations unlike FIG. 2, in the area 64 to which the exposure light or scattered light of the exposure light is not irradiated, fluorine contained resin 68 having a initially high contact angle is coated or formed. The fluorine contained resin 68 may have a single molecule layer having one end terminated with fluorine and the other end terminated with Si, or several molecule layers, or a composite material, such as PFA and PTFE.

The exposure apparatus 1 has a sensor (not shown) near the liquid holding plate 60. In order to prevent an intrusion of the liquid into an aperture between the sensor and the liquid holding plate, Parylene may be used for the side surface of the sensor.

Whether the liquid holding plate 60 has the structure of FIGS. 3A and 3B or the structure of FIGS. 4A and 4B, even the Parylene coated liquid holding plate 60 needs to be replaced to maintain a high contact angle for the performance of the exposure apparatus. However, in comparison with fluorine contained resin, the Parylene coated liquid holding plate 60 can remarkably reduce the exchange frequency, and improve the throughput of the exposure apparatus 1.

The liquid recovery unit 74 can sufficiently recover the liquid L when the contact angles to the liquid L of the surfaces of the liquid holding plate 60 and the wafer chuck 55 are maintained high for a long period. In addition, when the contact angles to the liquid L of the surfaces of the liquid holding plate 60 and the wafer chuck 55 are maintained high for a long period, the liquid L is not attracted to the aperture between the liquid holding plate 60 and the wafer chuck 55 or to the liquid holding plate 60, and supply/recovery controls of the liquid L becomes easier, restraining the removal, gasification, and disturbance of the liquid L at contact part that contacts the liquid L. In other words, this embodiment eliminates makes the liquid L free from impurities, and maintains constant the optical characteristic, thermal characteristic, etc. Thereby, this embodiment provides an exposure apparatus having a superior optical characteristic and productivity.

Thus, the exposure apparatus 1 can maintain the hydrophobic property of the surfaces of the liquid holding plate 60 and the wafer chuck 55 for a long period by coating them with Parylene or its modified layer. In other words, the contact angle can be maintained high for a long time by reducing a drop of the contact angle of each surface of the liquid holding plate 60 and the wafer chuck 55. Since the liquid L is not left on the liquid holding plate 60 and the wafer's rear surface, the wafer 40 can be quickly moved and a high throughput can be maintained. This embodiment can reduce the exchange frequency, and provides a higher productivity than that of the conventional exposure apparatus.

While this embodiment uses Parylene for the surfaces of the liquid holding plates (60, 62), and wafer chuck 55, similar effects are available with organic matter that contains chlorine, such as polychlorotrifluoroethylene resin (“PCTFE”) and its modified layer. PCTFE is resin in which fluorine is replaced with chlorine in poly tetra fluoro ethylene resin (“PTFE”), and its contact angle changes or increases similar to Parylene upon the UV irradiations. Therefore, the PCTEE coated surfaces of the liquid holding plate 60 and the wafer chuck 55 can also reduce a drop of the contact angle due to the exposure light irradiations, and provide an exposure apparatus having a superior optical characteristic and productivity.

While this embodiment uses Parylene for the surfaces of the liquid holding plate 60 and the wafer chuck 55, surfaces of other parts that contacts the liquid L in the exposure apparatus may use Parylene, PCTFE, or their modified layers.

In exposure, the light emitted from the light source 12 Koehler-illuminates the retile 20. The light that passes the reticle 20, and reflects the reticle pattern is imaged on the wafer 40 via the projection optical system 30 and the liquid L. The light holding plate 60 used for the exposure apparatus 1 reduces a drop of the contact angle due to the exposure light irradiation, and provides a good optical characteristic and productivity. Therefore, the exposure apparatus 1 can provide, with a good throughput and economical efficiency, higher quality devices, such as a semiconductor device and a liquid crystal device, than ever.

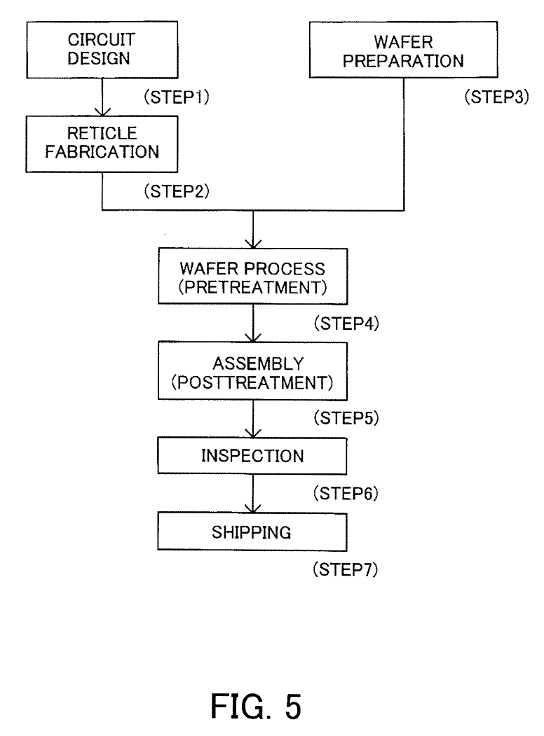

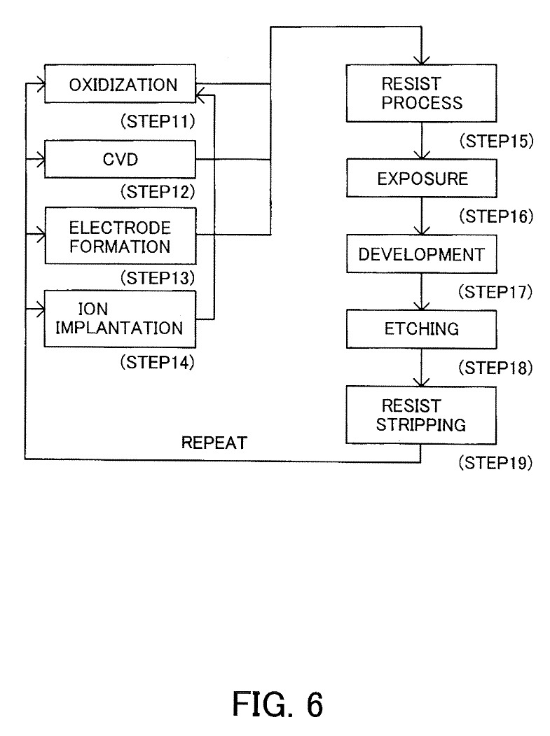

Referring now to FIGS. 5 and 6, a description will be given of an embodiment of a device manufacturing method using the exposure apparatus 1. FIG. 5 is a flowchart for explaining how to fabricate devices, such as a semiconductor device and a LCD device. Here, a description will be given of the fabrication of a semiconductor device as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 6 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern of the reticle onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device manufacturing method of this embodiment may manufacture higher quality devices than ever. Thus, the device manufacturing method using the exposure apparatus 1, and resultant devices constitute one aspect of the present invention.

Further, the present invention is not limited to these preferred embodiments and various variations and modifications may be made without departing from the scope of the present invention.

This application claims a foreign priority benefit based on Japanese Patent Applications Nos. 2006-026213, filed on Feb. 2, 2006 and 2007-017281, filed on Jan. 29, 2007, and each of which is hereby incorporated by reference herein in its entirety as if fully set forth herein.

What is claimed is:

1. An exposure apparatus for exposing a substrate via liquid, the exposure apparatus comprising:
a liquid holding plate configured to hold the liquid, and arranged around the substrate; and
a chuck configured to hold the substrate, at least one of at least part of a surface of the liquid holding plate and at least part of a surface of the chuck being made of polyparaxylene resin or including a modified layer of polyparaxylene resin.

2. An exposure apparatus according to claim 1, wherein at least one of at least part of the surface of the liquid holding plate and at least part of the surface of the chuck is coated with polyparaxylene resin or a modified layer of polyparaxylene resin.

3. An exposure apparatus according to claim 1, wherein the liquid holding plate has a first liquid holding plate that is arranged around the substrate, and a second liquid holding plate that is arranged around the first liquid holding plate, and
wherein at least part of a surface of the first liquid holding plate is made of polyparaxylylene resin or has a modified layer of polyparaxylylene resin, and at least part of a surface of the second liquid holding plate is made of fluorine contained resin.

4. An exposure apparatus configured to expose a substrate via liquid, said exposure apparatus comprising:
a liquid holding plate configured to hold the liquid, and arranged around the substrate; and
a chuck configured to hold the substrate, at least one of at least part of a surface of the liquid holding plate and at least part of a surface of the chuck being made of an organic material that contains chlorine.

5. An exposure apparatus according to claim 4, wherein at least one of at least part of the surface of the liquid holding plate and at least part of the surface of chuck is coated with the organic material that contains chlorine.

6. An exposure apparatus according to claim 4, wherein the liquid holding plate has a first liquid holding plate that is arranged around the substrate, and a second liquid holding plate that is arranged around the first liquid holding plate, and
wherein at least part of a surface of the first liquid holding plate is made of the organic material that contains chlorine, and at least part of a surface of the second liquid holding plate is made of fluorine contained resin.

7. A device manufacturing method comprising:
exposing a substrate via liquid using an exposure apparatus; and
developing the substrate that has been exposed,
wherein the exposure apparatus includes:
a liquid holding plate configured to hold the liquid, and arranged around the substrate; and
a chuck configured to hold the substrate, at least one of at least part of a surface of the liquid holding plate and at least part of a surface of the chuck being made of polyparaxylene resin or having a layer or modified layer of polyparaxylene resin.

8. A device manufacturing method comprising:
exposing a substrate via liquid using an exposure apparatus; and
developing the substrate that has been exposed,
wherein the exposure apparatus includes:
a liquid holding plate configured to hold the liquid, and arranged around the substrate; and
a chuck configured to hold the substrate, at least one of at least part of a surface of the liquid holding plate and at least part of a surface of the chuck being made of an organic material that contains chlorine.
